(19) United States
(12) Patent Application Publication
(10) Pub. No.: US 2015/0287966 A1
(43) Pub. Date: Oct. 8, 2015

(54) ELECTRODE ASSEMBLY AND SECONDARY BATTERY HAVING THE SAME

(71) Applicant: Samsung SDI Co., Ltd., Yongin-si (KR)

(72) Inventor: Kwui-Won Jeong, Yongin-si (KR)

(21) Appl. No.: 14/656,472

(22) Filed: Mar. 12, 2015

(30) Foreign Application Priority Data
Apr. 4, 2014 (KR) 10-2014-0040263

(51) Int. Cl. H01M 2/16; H01M 2/26; H01M 2/04

(52) U.S. Cl. CPC H01M 2/162; H01M 2/1673; H01M 2/1653; H01M 2/0469; H01M 2/266; H01M 2/04

(57) ABSTRACT

An electrode assembly and a secondary battery having the electrode assembly are provided. In one aspect, the electrode assembly comprises a first electrode plate, a first electrode tab attached to a first portion of the first electrode plate and extending outwardly from the first electrode plate, a second electrode plate placed over the first electrode plate, a second electrode tab attached to a second portion of the second electrode plate and extending outwardly from the second electrode plate, a separator interposed between the first and second electrode plates, and a reinforcing member interposed between two of the following: the first electrode plate, the second electrode plate, and the separator.

### CROSS-REFERENCE TO RELATED APPLICATION

This application claims priority to and the benefit of Korean Patent Application No. 10-2014-0040263, filed on Apr. 4, 2014, in the Korean Intellectual Property Office, the entire contents of which are incorporated herein by reference in their entirety.

### BACKGROUND

1. Field

The described technology generally relates to an electrode assembly and a secondary battery having the electrode assembly.

2. Description of the Related Technology

A secondary battery is a rechargeable battery, unlike a primary battery that is a non-rechargeable battery. Low-capacity secondary batteries are often used for portable and small electronic devices, such as mobile phones, notebook computers and camcorders, whereas high-capacity batteries are widely used as a power source for driving a motor of a hybrid vehicle or the like.

High-capacity and high-output secondary batteries with high-energy density using a non-aqueous electrolyte are being developed. Typically, a plurality of high-output secondary batteries is connected in series or in parallel, thus forming a high-output and high-capacity battery module.

Generally, the secondary battery is provided with an electrode assembly including a positive plate, a negative plate, and a separator interposed between the plates. Each of the positive and negative plates is formed by applying an active material to a current collector made of metal. The current collector includes a coating portion on which the active material is coated, and a non-coating portion on which no active material is coated.

### SUMMARY OF CERTAIN INVENTIVE ASPECTS

One inventive aspect is an electrode assembly and a secondary battery having the electrode assembly, in which a reinforcing member, having the same thickness as the thickness of an electrode tab, is inserted into a remaining area of the electrode assembly except an area where the electrode tab is positioned, thus improving the flatness of the battery and thereby being capable of pressurizing a whole surface of the battery with uniform force during a press process.

Another aspect is an electrode assembly, including a first electrode plate to which a first electrode tab is attached in such a way as to protrude upwards therefrom, a second electrode plate placed on the first electrode plate, a second electrode tab being attached to the second electrode plate in such a way as to protrude upwards therefrom, and a separator interposed between the first electrode plate and the second electrode plate, wherein a reinforcing member is inserted into the electrode assembly, the reinforcing member being shaped to correspond to a remaining area except an area of the first electrode plate to which the first electrode tab is attached and an area of the second electrode plate to which the second electrode tab is attached.

The first electrode plate, the separator, and the second electrode plate can be sequentially stacked and then wound.

The reinforcing member can have the same thickness as the first electrode tab or the second electrode tab.

The reinforcing member can be formed to have the thickness of 0.05 mm to 0.2 mm.

The first electrode tab and the second electrode tab can be formed at different positions on a wide surface of the electrode assembly.

The reinforcing member can include a first groove formed at a position corresponding to the area to which the first electrode tab is attached, and a second groove formed at a position corresponding to the area to which the second electrode tab is attached.

The first electrode tab and the second electrode tab can be formed on the wide surface of the electrode assembly in such a way as to overlap each other.

The thickness of the reinforcing member can be equal to a sum of thickness of the first electrode tab and thickness of the second electrode tab.

The reinforcing member can include a third groove formed at a position corresponding to the first and second electrode tabs.

The reinforcing member can be made of a porous material.

The reinforcing member can be made of the same material as the separator.

The reinforcing member can be made of polyethylene terephthalate (PET).

An outer surface of the reinforcing member can be coated with acryl, polymer, polyvinylidene difluoride (PVDF) or hydrogen vapor deposition (HVD).

Another aspect is a secondary battery, including an electrode assembly having a first electrode plate to which a first electrode tab is attached, a second electrode plate to which a second electrode tab is attached, and a separator interposed between the first electrode plate and the second electrode plate; a case configured to accommodate the electrode assembly therein, with the case being open at a top thereof; and a cap assembly configured to cover an opening of the case, wherein a reinforcing member is inserted into the electrode assembly, the reinforcing member being shaped to correspond to a remaining area except an area of the first electrode plate to which the first electrode tab is attached and an area of the second electrode plate to which the second electrode tab is attached.

Another aspect is an electrode assembly, comprising a first electrode plate, a first electrode tab attached to a first portion of the first electrode plate and extending outwardly from the first electrode plate, a second electrode plate placed over the first electrode plate, a second electrode tab attached to a second portion of the second electrode plate and extending outwardly from the second electrode plate, a separator interposed between the first and second electrode plates, and a reinforcing member interposed between two of the following: the first electrode plate, the second electrode plate, and the separator.

In the above electrode assembly, the first electrode plate, the separator, and the second electrode plate are sequentially stacked, wherein the electrode assembly further comprises a lamination tape wound around the first electrode plate, the separator, and the second electrode plate.

In the above electrode assembly, the reinforcing member has substantially the same thickness as that of the first or second electrode tab.

In the above electrode assembly, the reinforcing member has a thickness in the range of about 0.05 mm to about 0.2 mm.

In the above electrode assembly, the first and second electrode tabs are formed at different positions on the electrode assembly. In the above electrode assembly, the reinforcing member has first and second grooves formed respectively corresponding to the first and second portions.

In the above electrode assembly, the first and second electrode tabs at least partially overlaps each other. In the above electrode assembly, the thickness of the reinforcing member is substantially equal to the sum of the thicknesses of the first and second electrode tabs.

In the above electrode assembly, the reinforcing member has a third groove formed so as to correspond to the overlapping area of the first and second electrode tabs.

In the above electrode assembly, the reinforcing member is formed of a porous material.

In the above electrode assembly, the reinforcing member is formed of the same material as the separator.

In the above electrode assembly, the reinforcing member is formed of polyethylene terephthalate (PET).

In the above electrode assembly, an outer surface of the reinforcing member is coated with acryl, polymer, polyvinylidene difluoride (PVDF) or hydrogen vapor deposition (HVD).

In the above electrode assembly, at least a portion of the reinforcing member does not overlap the first and second portions of the first and second electrode plates, respectively.

Another aspect is a secondary battery, comprising an electrode assembly, a case configured to accommodate the electrode assembly therein, wherein the case has an open top; and a cap assembly configured to substantially cover the open top. The electrode assembly comprises a first electrode plate, a first electrode tab attached to a first portion of the first electrode plate and extending outwardly from the first electrode plate, a second electrode plate placed over the first electrode plate, a second electrode tab attached to a second portion of the second electrode plate and extending outwardly from the second electrode plate, a separator interposed between the first and second electrode plates, and a reinforcing member interposed between two of the following: the first electrode plate, the second electrode plate, and the separator.

In the above secondary battery, at least a portion of the reinforcing member does not overlap the first and second portions of the first and second electrode plates, respectively.

In the above secondary battery, the first electrode plate, the separator, and the second electrode plate are sequentially stacked, wherein the electrode assembly further comprises a lamination tape wound around the first electrode plate, the separator, and the second electrode plate.

In the above secondary battery, the reinforcing member has substantially the same thickness as that of the first or second electrode tab.

In the above secondary battery, the reinforcing member has a thickness of between about 0.05 mm to about 0.2 mm.

In the above secondary battery, the first and second grooves have substantially the same shape.

As is apparent from the above description, the described technology is advantageous in that the reinforcing member, having the same thickness as the thickness of the electrode tab, is inserted into the electrode assembly, thus improving the flatness of the battery, and allowing press pressure to be uniformly applied to the whole surface. Thereby, the non-uniformity of the pressure is solved, so that appearance can be improved, and besides, the deformation of the battery can be prevented after its lifespan.

### BRIEF DESCRIPTION OF THE DRAWINGS

FIG. 1 is an exploded perspective view showing a secondary battery according to an embodiment.

FIG. 2 is a perspective view showing a process of heat-pressing an electrode assembly according to the embodiment.

FIG. 3 is a plan view showing a state in which a reinforcing member is positioned in the electrode assembly, according to the embodiment.

FIG. 4A is a side view showing the electrode assembly according to the embodiment.

FIG. 4B is a top view showing the electrode assembly according to the embodiment.

FIG. 5 is an exploded perspective view showing a secondary battery according to another embodiment.

### DETAILED DESCRIPTION OF CERTAIN INVENTIVE EMBODIMENTS

The electrode assembly is wound or stacked and then is heat-pressed. The heat-pressed electrode assembly's strength increases so as to maintain a shape against external shocks. The thickness of the battery cell is reduced so as to increase energy density per unit volume. Further, the thinner electrode assembly can be easily inserted into a case.

The described technology will be described more fully hereinafter with reference to the accompanying drawings, in which example embodiments of the described technology are shown.

In the following description, if it is decided that the detailed description of known function or configuration related to the described technology makes the subject matter of the described technology unclear, the detailed description is omitted. Further, like reference numerals are used to identify like elements throughout different drawings. Furthermore, the drawings are not intended to depict every feature of embodiments nor relative dimensions of the depicted elements, and are not drawn to scale. In this disclosure, the term “substantially” includes the meanings of completely, almost completely or to any significant degree under some applications and in accordance with those skilled in the art. Moreover, “formed on” can also mean “formed over.”

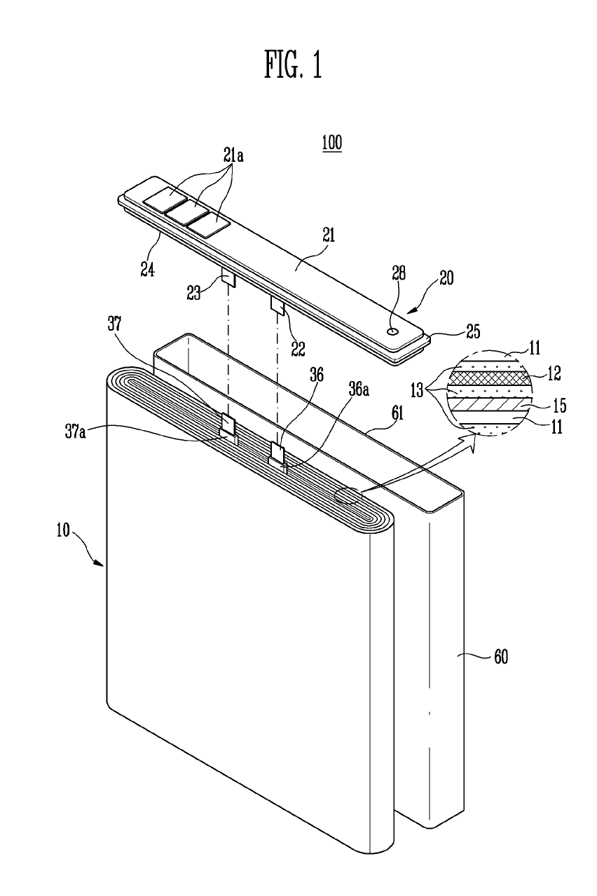

FIG. 1 is an exploded perspective view showing a secondary battery according to an embodiment.

Referring to FIG. 1, the secondary battery 100 according to the embodiment includes an electrode assembly 10, a cap assembly 20, and a case 60 coupled to the cap assembly 20. Although a square-shaped battery is described herein, the described technology is not limited thereto. The described technology can be applied to various secondary batteries, including a pouch battery, a lithium polymer battery and others.

The electrode assembly 10 includes a positive plate 11, a negative plate 12, and a separator 13 interposed therebetween. The positive plate 11 can have a substantially long band shape, and includes a positive coating portion on which an active positive polar material is formed. The positive plate 11 also includes a positive non-coating portion on which the active positive polar material is not coated. Here, the positive non-coating portion is provided on an end of the positive plate 11 in a longitudinal direction thereof, but is not limited thereto.

Further, the negative plate 12 can have a substantially long band shape, and includes a negative coating portion on which an active negative polar material is formed. The negative plate 12 also includes a negative non-coating portion on which the active negative polar material is not coated. Here, the negative non-coating portion is provided on an end of the negative plate 11 in a longitudinal direction thereof, but is not limited thereto.

The separator 13, which is a porous insulator, is interposed between the positive plate 11 and the negative plate 12 and then is wound in the shape of a jelly roll. That is, after the positive plate 11, the separator 13 and the negative plate 12 are sequentially stacked, they are wound, thus forming the electrode assembly 10.

One end of a positive tab 36 is attached to the positive plate 11, and one end of a negative tab 37 is attached to the negative plate 12. Further, the other ends of each of the positive and negative tabs 36 and 37 protrude upwards from the electrode assembly 10 so as to be exposed to the outside.

Lamination tapes 36a and 37a are wound around portions of the positive and negative tabs 36 and 37. The lamination tapes 36a and 37a can substantially block heat generated from the positive and negative tabs 36 and 37. Further, the lamination tapes 36a and 37a can prevent the electrode assembly 10 from being pressurized by edges of the positive and negative tabs 36 and 37.

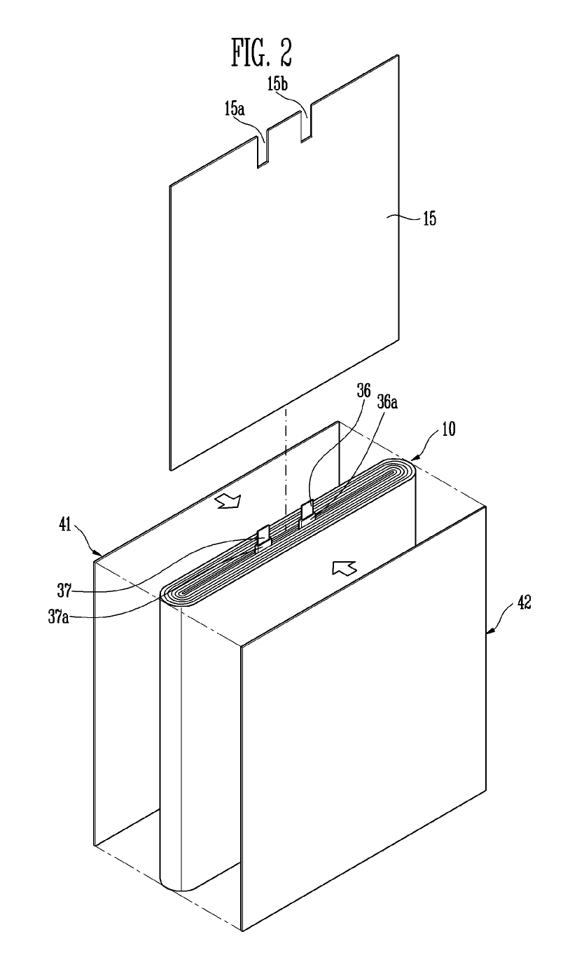

Further, a plate-shaped reinforcing member 15 can be inserted into a remaining area of the positive and negative plates 36 and 37 of the electrode assembly 10, except areas where the positive and negative tabs 36 and 37 are attached. That is, as shown in FIG. 2, the reinforcing member 15 includes a first groove 15a formed at an area corresponding to the positive tab 36, and a second groove 15b formed at an area corresponding to the negative tab 37.

As such, according to the first embodiment of the described technology, the reinforcing member 15 is inserted into the electrode assembly 10, thus improving flatness on substantially the whole surface of the electrode assembly 10. As for a general secondary battery, an area of the electrode plate where the electrode tab is welded is thicker than the remaining area, thus causing a difference in flatness of the battery itself due to a difference in thickness between the two areas. Therefore, generally, the battery can have an undesirable non-uniform thickness.

After the winding is performed, the electrode assembly is heat-pressed. The strength of the heat-pressed electrode assembly increases so as to maintain a shape against external shocks. The thickness of a cell reduces, so that energy density per unit volume increases. Further, it is easy to insert the electrode assembly into the case because the electrode assembly has a reduced thickness due to the heat press.

Thus, when the electrode assembly is generally heat-pressed, the area where the electrode tab is welded increases in thickness, and therefore the pressure is not uniformly distributed throughout the battery. Further, the non-uniformity can reduce battery lifetime and cause the battery to be undesirably deformed while being used.

Therefore, as in the first embodiment, the reinforcing member 15 can be inserted into the electrode assembly 10, thus decreasing the non-uniformity of the pressure when the electrode assembly 10 is heat-pressed. The insertion can therefore improve the appearance of the battery (i.e., flatten the surface thereof) and prevent the deformation of the battery while being used.

The cap assembly 20 includes a circuit board 21, a first lead tab 22, and a second lead tab 23. The cap assembly 20 is coupled to an opening 61 of the case 60, and is connected to the electrode assembly 10. Therefore, the cap assembly 20 can control the operation of the electrode assembly 10.

The first lead tab 22 can be formed of an electrically conductive material such as nickel, and is electrically connected to the circuit board 21. Further, the first lead tab 22 electrically connects the circuit board 21 to the electrode assembly 10, and is formed at a central portion on a first surface of the circuit board 21. The first lead tab 22 can be connected to the positive tab 36 by welding.

The second lead tab 23 is provided on an end of the circuit board 21 in a longitudinal direction thereof, and electrically connects the circuit board 21 to the electrode assembly 10. Further, the second lead tab 23 can be formed of an electrically conductive material such as nickel, and connected to the negative tab 37 by welding.

The circuit board 21 can be a printed circuit board (PCB) on which a wiring pattern is printed, and is formed in the shape of a thin, substantially rectangular plate which extends in a long direction. A protective circuit element is mounted on the circuit board 21. In this regard, the protective circuit element includes a control integrated circuit (IC), a charging/discharging switch, and other elements. Further, a molding portion 24 is formed on a bottom of the circuit board 21 to substantially surround the protective circuit element.

Further, an external terminal 21a is provided on the circuit board 21 and electrically connected to an external load or a charger. An electrolyte inlet port is formed in the circuit board 21 so as to inject an electrolyte, and a sealing stopper 28 is fitted into the electrolyte inlet port so as to close the port.

In some embodiments, a joining portion 25 is formed along an edge of the cap assembly 20 and substantially overlaps the circuit board 21 when seen from a top of the cap assembly 20. The circuit board 21 can be substantially rectangular, and the joining portion 25 protrudes outwards from a side of the circuit board 21. The joining portion 25 can be joined to the opening 61 through the welding process or the like, thus substantially sealing the case 60.

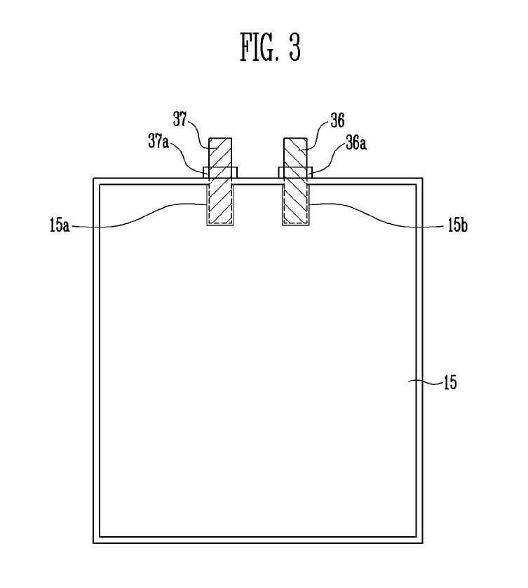

FIG. 2 is a perspective view showing the process of heat-pressing the electrode assembly according to the FIG. 1 embodiment. FIG. 3 is a plan view showing the state in which the reinforcing member is positioned in the electrode assembly according to the embodiment.

Referring to FIGS. 2 and 3, the electrode assembly 10 is configured as follows. When the positive and negative tabs 36 and 37 respectively protrude upwards from the positive and negative plates 11 and 12, the positive plate 11, the separator 13 and the negative plate 12 are sequentially stacked and then wound as described above.

Further, the reinforcing member 15 can be inserted into the remaining area of the electrode assembly 10, except the areas to which the positive tab 36 and the negative tab 37 are attached. The reinforcing member 15 can include the first groove 15a formed at a position corresponding to the area where the positive tab 36 is welded, and the second groove 15b formed at a position corresponding to the area where the negative tab 37 is welded. Here, the positive and negative tabs 36 and 37 can be formed at different positions on the wide surface of the electrode assembly 10.

The electrode assembly 10 is heat-pressed by first and second pressurizing members 41 and 42. By pressurizing the electrode assembly 10 using the first and second pressurizing members 41 and 42 that are heated, the positive and negative plates 11 and 12 come into contact with the separator 13.

In some embodiments, the reinforcing member 15 can have substantially the same thickness as that of the positive tab 36 or the negative tab 37. Thus, when the electrode assembly 10 is pressurized by the first and second pressurizing members 41 and 42, the positive and negative tabs 36 and 37 can substantially fit in the first and second grooves 15a and 15b that are formed in the reinforcing member 15, respectively, so that the whole surface of the electrode assembly 10 can be substantially flat.

Such a reinforcing member 15 can be formed of a porous material, and can be formed of the same material as the separator 13. Moreover, the reinforcing member 15 can be formed of polyethylene terephthalate (PET) and therefore, the electrolyte can pass through the reinforcing member 15.

Further, the outer surface of the reinforcing member 15 can be coated with acryl, polymer, polyvinylidene difluoride (PVDF) or hydrogen vapor deposition (HVD).

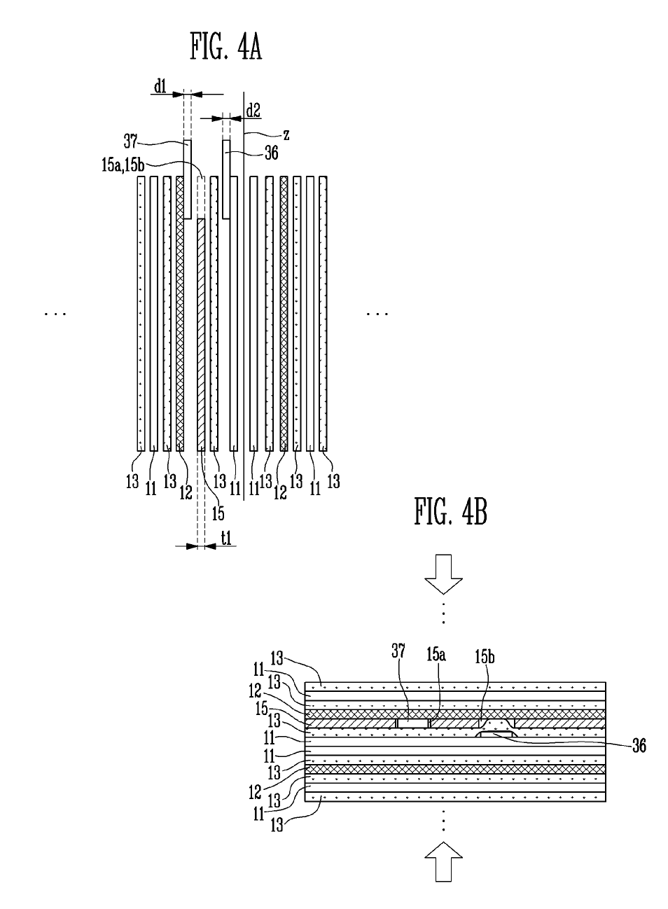

FIG. 4A is a side view showing the electrode assembly according to the embodiment of the described technology. FIG. 4B is a top view showing the electrode assembly according to the embodiment of the described technology.

Referring to FIGS. 4A and 4B, the electrode assembly 10 has a bilateral, substantially symmetric structure with respect to a winding axis (Z) that is positioned at substantially the center thereof. That is, the positive plate 11 is arranged substantially nearest to the winding axis Z, the separator 13 is arranged outside the positive plate 11, and the negative plate 12 is arranged outside the separator 13. Further, another separator 13 is arranged outside the negative plate 12. Subsequently, the positive plate 11, the separator 13 and the negative plate 12 are repeated in the above-mentioned order, thus forming the wound electrode assembly 10.

For the convenience of description, FIGS. 4A and 4B show that the positive plate 11, the separator 13 and the negative plate 12 are spaced apart from each other at predetermined intervals. Further, the lamination tapes 36a and 37a (see FIG. 2) wind around the portions of the positive and negative tabs 36 and 37, which protrude from the electrode assembly 10, are omitted.

The positive and negative tabs 36 and 37 can be attached to the positive and negative plates 11 and 12, respectively, by welding. The positive and negative tabs 36 and 37 are formed at different positions on the wide surface of the electrode assembly 10.

Further, the reinforcing member 15 is inserted into an area of the electrode assembly 10. The reinforcing member 15 can have a plate shape to correspond to the remaining area of the electrode assembly 10, except the area of the positive plate 11 where the positive tab 36 is attached and the area of the negative plate 12 where the negative tab 37 is attached. The reinforcing member 15 includes the first and second grooves 15a and 15b formed at positions respectively corresponding to the areas where the positive and negative tabs 36 and 37 are attached.

In the first embodiment, the reinforcing member 15 is positioned between the negative plate 12 and the separator 13. Thereby, the negative tab 37 is accommodated in the second groove 15b of the reinforcing member 15.

The separator 13 is accommodated in a curved manner in the first groove 15a. Further, the positive tab 36 is accommodated in a curved space created in the separator 13 when the separator 13 is accommodated in the first groove 15a.

Here, the reinforcing member 15 can have substantially the same thickness as that of the positive tab 36 or the negative tab 37. The reinforcing member 15 can have a thickness of about 0.05 mm to about 0.2 mm. That is, when the reinforcing member 15 has substantially the same thickness as that of the positive tab 36 or the negative tab 37, the first groove 15a and the second groove 15b can compensate for the thickness of the positive tab 36 and the negative tab 37. However, depending on embodiments, the thickness can be less than about 0.05 mm or greater than about 0.2 mm.

When the thickness of the negative tab 37 is d1 and the thickness of the positive tab 36 is d2, the thickness t1 of the reinforcing member 15 can be formed to be substantially equal to the thickness d1 or d2. Therefore, the flatness of the electrode assembly 10 can increase, so that the surface of the battery is subjected to the same pressure during the heat press. This enables the appearance of the battery to be substantially uniform and can prevent the battery from being deformed during its use.

As such, the electrode assembly and the secondary battery according to the described technology can improve the flatness of the outer surface due to the insertion of the reinforcing member. This can cause the battery to be resistant against a collision and increase the lifespan of the battery.

Generally, when the battery is heat-pressed, the pressurizing member strongly pressurizes the area having the electrode tab, so that the area having the electrode tab experiences more deterioration. In particular, a negative-tab side experiences more deterioration as compared to a positive-tab side. However, according to some inventive embodiments, the reinforcing member is inserted into the electrode assembly which can improve the flatness of the surface of the battery and solve the above problems.

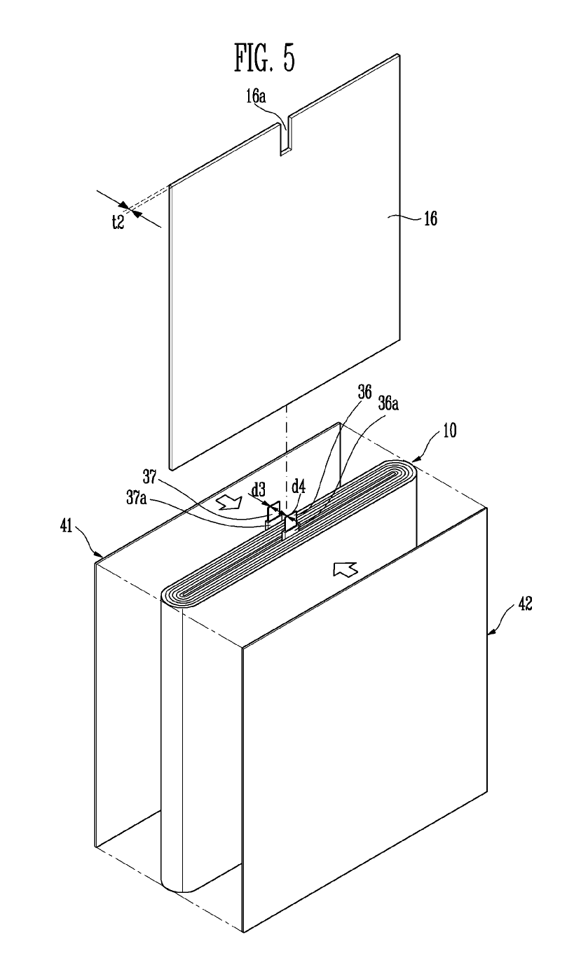

FIG. 5 is an exploded perspective view showing a secondary battery according to another embodiment.

Referring to FIG. 5, the secondary battery is formed by sequentially stacking the positive plate 11, the separator 13 and the negative plate 12 and then winding them, as in the first embodiment. Further, the positive tab 36 and the negative tab 37 are attached to the positive plate 11 and the negative plate 12, respectively, and protrude upwards from the electrode assembly 10.

In some embodiments, the plate-shaped reinforcing member 16, corresponding to the remaining area of the electrode assembly 10, is inserted into the electrode assembly 10.

In this regard, the positive tab 36 and the negative tab 37 can be formed on the wide surface of the electrode assembly 10 and substantially overlap each other.

A third groove 16a is formed in the reinforcing member 16 at a position corresponding to the positive tab 36 and the negative tab 37. Here, the reinforcing member 16 can have a thickness that is substantially equal to the sum of the thickness of the positive tab 36 and the thickness of the negative tab 37.

Therefore, when the electrode assembly 10 is pressurized using the first pressurizing member 41 and the second pressurizing member 42, the reinforcing member 16 can compensate for the thickness of the areas where the positive tab 36 and the negative tab 37. That is, when the thickness of the negative tab 37 is d3 and the thickness of the positive tab 36 is d4, the thickness t2 of the reinforcing member 16 can be substantially equal to equal to d3+d4.

Although the above embodiment is described with the winding-type electrode assembly as an example, the described technology can naturally employ a stack-type electrode assembly.

The inventive technology has been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment can be used singly or in combination with features, characteristics, and/or elements described in connection with other embodiments unless otherwise specifically indicated. Accordingly, it will be understood by those of skill in the art that various changes in form and details can be made without departing from the spirit and scope of the present invention as set forth in the following claims.

What is claimed is:

1. An electrode assembly, comprising:
a first electrode plate;
a first electrode tab attached to a first portion of the first electrode plate and extending outwardly from the first electrode plate;
a second electrode plate placed over the first electrode plate;
a second electrode tab attached to a second portion of the second electrode plate and extending outwardly from the second electrode plate;
a separator interposed between the first and second electrode plates; and
a reinforcing member interposed between two of the following: the first electrode plate, the second electrode plate, and the separator.

2. The electrode assembly of claim 1, wherein the first electrode plate, the separator, and the second electrode plate are sequentially stacked, and wherein the electrode assembly further comprises a lamination tape wound around the first electrode plate, the separator, and the second electrode plate.

3. The electrode assembly of claim 1, wherein the reinforcing member has substantially the same thickness as that of the first or second electrode tab.

4. The electrode assembly of claim 1, wherein the reinforcing member has a thickness in the range of about 0.05 mm to about 0.2 mm.

5. The electrode assembly of claim 1, wherein the first and second electrode tabs are formed at different positions on the electrode assembly.

6. The electrode assembly of claim 5, wherein the reinforcing member has first and second grooves formed respectively corresponding to the first and second portions.

7. The electrode assembly of claim 1, wherein the first and second electrode tabs at least partially overlaps each other.

8. The electrode assembly of claim 7, wherein the thickness of the reinforcing member is substantially equal to the sum of the thicknesses of the first and second electrode tabs.

9. The electrode assembly of claim 7, wherein the reinforcing member has a third groove formed so as to correspond to the overlapping area of the first and second electrode tabs.

10. The electrode assembly of claim 1, wherein the reinforcing member is formed of a porous material.

11. The electrode assembly of claim 10, wherein the reinforcing member is formed of the same material as the separator.

12. The electrode assembly of claim 10, wherein the reinforcing member is formed of polyethylene terephthalate (PET).

13. The electrode assembly of claim 1, wherein an outer surface of the reinforcing member is coated with acryl, polymer, polyvinylidene difluoride (PVDF) or hydrogen vapor deposition (HVD).

14. The electrode assembly of claim 1, wherein at least a portion of the reinforcing member does not overlap the first and second portions of the first and second electrode plates, respectively.

15. A secondary battery, comprising:
an electrode assembly;
a case configured to accommodate the electrode assembly therein, wherein the case has an open top; and
a cap assembly configured to substantially cover the open top,
wherein the electrode assembly comprises:
a first electrode plate;
a first electrode tab attached to a first portion of the first electrode plate and extending outwardly from the first electrode plate;
a second electrode plate placed over the first electrode plate;
a second electrode tab attached to a second portion of the second electrode plate and extending outwardly from the second electrode plate;
a separator interposed between the first and second electrode plates; and
a reinforcing member interposed between two of the following: the first electrode plate, the second electrode plate, and the separator.

16. The secondary battery of claim 15, wherein at least a portion of the reinforcing member does not overlap the first and second portions of the first and second electrode plates, respectively.

17. The secondary battery of claim 15, wherein the first electrode plate, the separator, and the second electrode plate are sequentially stacked, and wherein the electrode assembly further comprises a lamination tape wound around the first electrode plate, the separator, and the second electrode plate.

18. The secondary battery of claim 15, wherein the reinforcing member has substantially the same thickness as that of the first or second electrode tab.

19. The secondary battery of claim 15, wherein the reinforcing member has a thickness of between about 0.05 mm to about 0.2 mm.

20. The secondary battery of claim 15, wherein the first and second grooves have substantially the same shape.
